(19) United States
(12) Patent Application Publication
(10) Pub. No.: US 2007/0204289 A1
(43) Pub. Date: Aug. 30, 2007

(54) Digital television signal, method of processing digital television signal, and digital television receiver

(76) Inventor: So Young Kim, Seoul (KR)

Correspondence Address: MCKENNA LONG & ALDRIDGE LLP;Song K. Jung, 1900 K Street, N.W., Washington, DC, 20006, US

(21) Appl. No.: 11/417,169

(22) Filed: May 4, 2006

(30) Foreign Application Priority Data
Feb. 24, 2006 (KR) 10-2006-0018486

(51) Int. Cl. H04N 5/445; G06F 13/00; H04N 7/16

(52) U.S. Cl. 725/28; 725/39; 725/52

(57) ABSTRACT

A digital television signal for use in a digital television receiver includes a rating region table carrying rating information for multiple geographical regions. The rating region table includes a multiple string structure containing a multiple string structure which represents a name of a dimension, rating value information defining one or more rating values associated with the dimension, and a data field including information specifying a change mode of the rating value information. The change mode indicates whether and how the rating value information is changed. For example, it may indicate whether there is a change in the rating value information. If there is, it may further indicate whether a new rating value is simply appended or any existing rating value has been changed or deleted. In addition, it may further indicate whether the dimension is a valid dimension.

This application claims the benefit of the Korean Patent Application No. 10-2006-0018486, filed on Feb. 24, 2006, which is hereby incorporated by reference as if fully set forth herein.

### BACKGROUND OF THE INVENTION

1. Field of the Invention

The present invention relates to a digital television signal, and more particularly, to a digital television signal, a method of receiving the digital television signal, and a digital television receiver. Although the present invention is suitable for a wide scope of applications, it is particularly suitable for providing convenient rating settings, so as to allow the user to easily recognize any change in a rating region table (RRT).

2. Discussion of the Related Art

A program and system information protocol (PSIP) is defined for parsing messages encoded in specific modes, such as MPEG-2 (moving pictures experts group), so as to provide diverse information on a particular digital broadcast program. The PSIP basically has the same structure as a PSI of the MPEG system. The PSIP may also be configured of a group of tables having the same object or purpose. Herein, each of the tables may be divided into several sections and then transmitted. Such tables include a virtual channel table (VCT), a system time table (STT), a rating region table (RRT), an extended text table (ETT), a direct channel change table (DCCT) and/or a direct channel change selection code table (DCCSCT), an event information table (EIT), a program map table (PMT), and a master guide table (MGT).

More specifically, the STT provides time information of the broadcast program, and the RRT transmits information on a specific region and an advisory committee for the program rating. The ETT provides additional channel and broadcast program description. The DCCT and the DCCSCT are related with automatic (or direct) change in channels. The EIT provides event information (e.g., title, starting time, etc.) of a virtual channel. Finally, the MGT is for managing versions and PID of each of the above-mentioned tables. Particularly, among the above-mentioned tables, the RRT is configured with information of a program rating system existing in a specific region. The RRT is a standard table for a ‘Content_Advisory_Descriptor’, which indicates event schedules and program ratings existing in the EIT or the PMT, wherein information of each event is included.

However, the related art digital television signal including a rating region table (RRT) of a program and system information protocol (PSIP), and method and apparatus for processing the digital television signal have the following disadvantages. When the RRT is downloadable, a value pre-set by the user already exists. Accordingly, even though a new version RRT is received, the pre-set value should be maintained. Therefore, there lies a problem in that, in the downloadable RRT, a new dimension can only be added to the end of the previous dimension and cannot be modified. Further, the size of the RRT including the header and the trailer of a section cannot exceed 1024 bytes. Thus, the number of dimensions that is added to the RRT is limited.

### SUMMARY OF THE INVENTION

Accordingly, the present invention is directed to a digital television signal, a method of receiving the digital television signal, and a digital television receiver that substantially obviate one or more problems due to limitations and disadvantages of the related art.

An object of the present invention is to provide a digital television signal, a method of receiving the digital television signal, and a digital television receiver that can provide convenient rating settings, so as to allow the user to easily recognize any change in a rating region table (RRT).

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a digital television signal for use in a digital television receiver includes a rating region table carrying information for digital geographical regions. The rating region table includes a first multiple string structure containing a first multiple string structure which represents a name of a dimension, rating value information defining one or more rating values associated with the dimension, and a data field including information which specifies a change mode of the rating value information.

In one example, the change mode may be any one of a first mode in which a new rating value is appended, and a second mode in which a rating value is changed or deleted. In another example, the change mode may be any one of a first mode in which a new rating value is appended, a second mode in which a rating value is changed or deleted, a third mode indicating that the dimension is invalid, and a fourth mode indicating that the dimension is valid. In another example, the change mode may be any one of a first mode in which there is no change in the rating value information, a second mode in which a new rating value is appended, and a third mode in which a rating value is changed or deleted. In another example, the change mode may be any one of a first mode in which there is no change in the rating value information, and a second mode in which there is a change in the rating value information.

In another aspect of the present invention, a digital television receiver includes a tuner, a demodulator, a demultiplexer, a decoder, and a controller. The tuner receives a digital television signal from a broadcast transmitter. The demodulator demodulates the digital television signal, and the demultiplexer demultiplexes a rating region table from the demodulated digital television signal. The decoder parses the rating region table. The rating region table parsed by the decoder includes rating value information and a data field. The rating value information defines one or more rating values associated with a dimension, and the data field includes information which specifies a change mode of the rating value information. The controller controls storage of the rating value information based upon the change mode of the rating value information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 illustrates a bit stream syntax for a rating region table (RRT) according to the present invention;

FIG. 2 illustrates an example of a syntax for applying a changed state of a dimension included in the rating region table (RRT) of a program and system information protocol (PSIP) according to the present invention;

FIG. 3 illustrates another example of a syntax for applying a validity and a changed state of a dimension included in the rating region table (RRT) of a program and system information protocol (PSIP) according to the present invention;

FIG. 4 illustrates an example of the structure of a digital television receiver for receiving and processing the rating region table (RRT) of a program and system information protocol (PSIP) according to the present invention; and

FIG. 5 illustrates a flow chart showing the process steps of a method for receiving and processing the rating region table (RRT) of a program and system information protocol (PSIP) according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention relates to a digital television signal, a method of receiving the digital television signal, and a digital television receiver. Herein, among a plurality of tables within a program and system information protocol (PSIP), the digital television signal includes a rating region table (RRT) carrying rating information for multiple geographical regions. The PSIP is used for tuning channels and transmitting program schedules in a terrestrial or cable digital broadcast environment.

The preferred embodiments of the present invention will now be described in detail with reference to the appended drawings. For a clearer understanding of the present invention, the description of the present invention will consist of a digital television signal including a RRT syntax according to the present invention; a block diagram of a method for receiving and processing the RRT included in the PSIP according to the present invention; and a method for processing the rating region table (RRT) included in the PSIP according to the present invention.

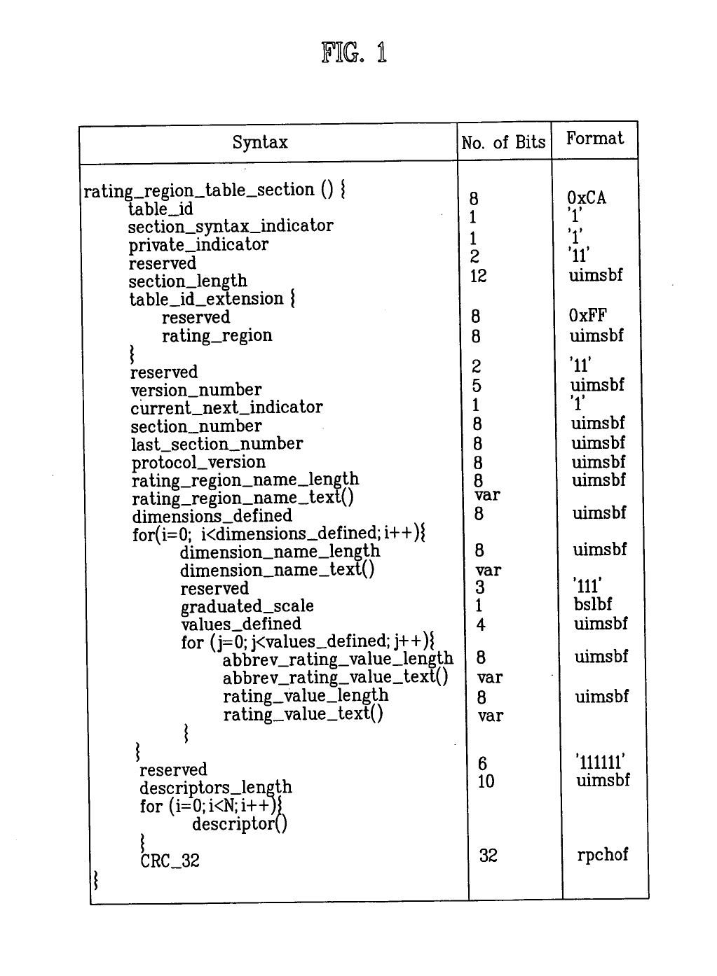

FIG. 1 illustrates a bit stream syntax for a rating region table (RRT) according to the present invention. In describing the syntax, the structure of a section which is configured by a combination of data structures will first be described. According to the present invention, all of the sections of the tables included in the PSIP begin with a “table_id” field and end with a “CRC_{—}32” field. Each section is divided into a header, a body, and a trailer. The header has a configuration common to all sections. And, the actual data is recorded in the body depending upon the object of the table section. Finally, the trailer checks and corrects the errors that may occur in the table section. More specifically, the header part begins from the “table_id” field to a “protocol_version” field. The body part begins from a “rating_region_name_length” field to a “descriptor( )” field. The trailer consists of the “CRC_{—}32” field.

Hereinafter, the RRT according to the present invention will be described. The header is also configured of a header, a body, and a trailer, each of which will now be described in detail. Furthermore, in order to simplify the description of the present invention, each field name of the syntax will be marked with quotation marks (e.g., “XXX_YYY_ZZZ”).

In the header, a “table_id” field is an 8-bit field, which shall be set to ‘0XCA’. The “table_id” field identifies the table as the rating region table (RRT). A “section_syntax_indicator” field is a 1-bit field, which shall be set to ‘1’. This field denotes that the section follows the generic section syntax beyond the section length field. A “private_indicator” field is a 1-bit field, which shall be set to ‘1’. A “section_length” field is a 12-bit field specifying the number of remaining bytes in the section immediately following the “section_length” field up to the end of the section. The value of the “section_length” field shall be no larger than 1021.

A “rating_region” field is an 8-bit unsigned integer number that defines the rating region to be associated with the text in the “rating_region_table_section( )”. The value of this field is the identifier of the corresponding rating region. Therefore, this field may be used by the other tables (e.g., a master guide table (MGT)) for referring to a specific rating region table. A rating region value of ‘0x00’ shall now be used. This field shall only contain values in the range of ‘0x01˜0xFF’ that have been defined by the ATSC. Contact ATSC for current assignment of values for the “rating_region” field.

A “version_number” field is a 5-bit field, wherein the version number of the rating region table is identified by a combination of the “table_id” field and the “table_id_extension” field. The version number shall be incremented by 1 modulo 32 when any field of the rating region table changes. The value of this field shall be the same as that of the corresponding entry in the MGT. A “current_next_indicator” field is a 1-bit indicator, which is always set to ‘1’. A “section_number” field is an 8-bit field, the value of which shall always be ‘0x00’. A “last_section_number” field is an 8-bit field, the value of which shall always be ‘0x00’. A “protocol_version” field is an 8-bit field, the value of which shall always be ‘0x00’.

According to the present invention, the body part will be described later on except fields to follow. A “descriptors_length” field is the total length (in bytes) of all of the descriptors that follow this field. Further, a “descriptor( )” field has zero (0) or more descriptors, as appropriate, may be included. Finally, in the trailer, a “CRC_{—}32” field is a 32-bit field that contains the CRC value which ensures a zero (0) output from the registers in the decoder after processing the entire rating region table (RRT) section.

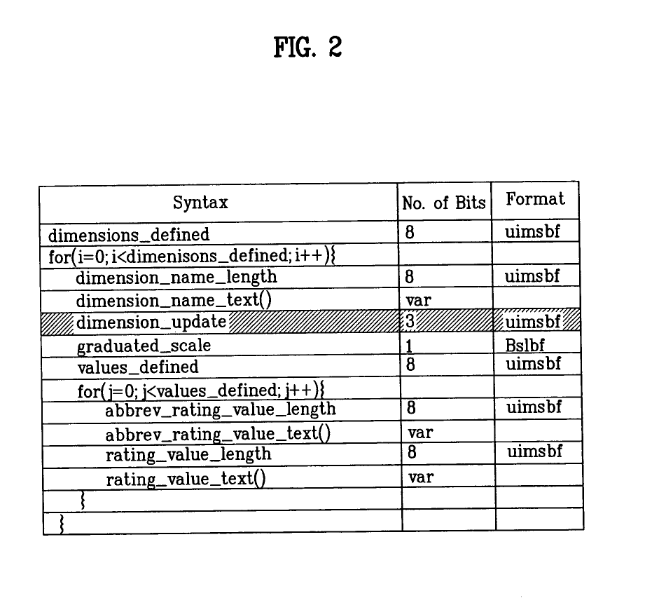

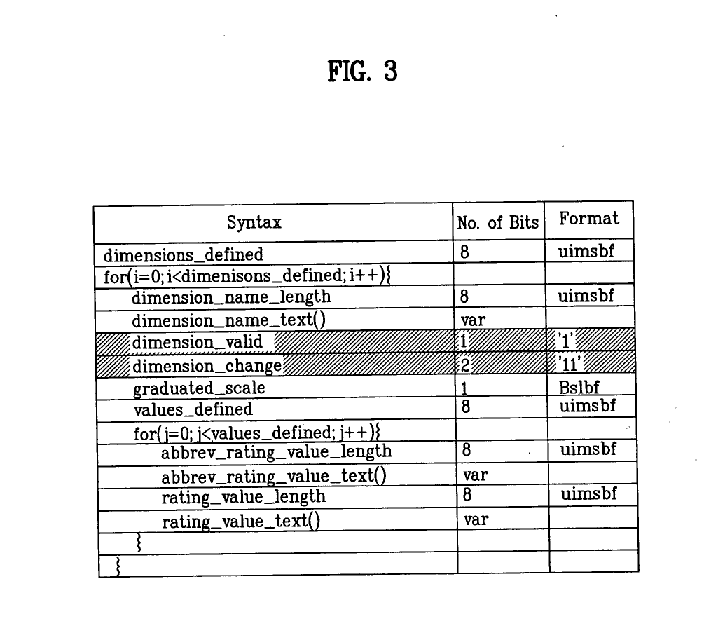

According to the present invention, the body part will now be described. FIG. 2 illustrates an example of a syntax for applying a changed mode of a dimension included in the rating region table (RRT) of a program and system information protocol (PSIP) according to the present invention. And, FIG. 3 illustrates another example of a syntax for applying a validity and a changed mode of a dimension included in the rating region table (RRT) of a program and system information protocol (PSIP) according to the present invention.

A “rating_region_name_length” field is an 8-bit unsigned integer number that defines the total length (in bytes) of a “rating_region_name_text( )” field to follows. The “rating_region_name_text( )” field is a data structure containing a multiple string structure which represents the rating region name, e.g., “U.S. (50 states+possessions)”, associated with the value given by the “rating_region” field. The display string for the rating region name shall be limited to 32 characters or less.

A “dimensions_defined” field is an 8-bit field (1-255), which specifies the number of dimensions defined in the “rating_region_table_section( )” field. A “dimension_name_length” field is an 8-bit unsigned integer number that defines the total length in bytes of a “dimension_name_text( )” field to follow. The “dimension_name_text( )” field is a data structure containing a multiple string structure which represents the dimension name that is described in the loop. One dimension in the U.S. rating region, for example, is used to describe the MPAA list. The dimension name for such a case may be defined as “MPAA”. The dimension name display string shall be limited to 20 characters or less.

A “graduated_scale”, field is a 1-bit flag, which indicates whether or not the rating values in this dimension represent a graduated scale (i.e., higher rating values represent increasing levels of rated content within the dimension). Herein, value ‘1’ means ‘yes’, while value ‘0’ means ‘no’. A “values_defined” field is a 4-bit field (1-15), which specifies the number of values defined for this particular dimension. An “abbrev_rating_value_length” field is an 8-bit unsigned integer number that defines the total length (in bytes) of an “abbrev_rating_value_text( )” field to follow. The “abbrev_rating_value_text( )” is a data structure containing a multiple string structure, which represents the abbreviated name for one particular rating value. The abbreviated name for rating value ‘0’ shall be set to a null string, i.e., “ ”. The abbreviated value display string shall be limited to 8 characters or less.

A “rating_value_length” field is an 8-bit unsigned integer number that defines the total length (in bytes) of the “rating_value_text( )” field to follow. A “rating_{—}value_text( )” field is a data structure containing a multiple string structure, which represents the full name for one particular rating value. The full name for rating value ‘0’ shall be set to a null string, i.e., “ ”. The rating value display string shall be limited to 150 characters or less.

Referring to FIG. 2, the “dimension_update” field is a 3-bit field defined to apply a changed mode of a dimension according to the present invention. In other words, when the version number of the RRT is updated and when a new dimension is applied accordingly, instead of applying the original settings made by the user as they are, a 3-bit field is used to define the changed mode of the dimension in the RRT, so as to determine whether an update is to be made by changing the original settings. For example, the changed mode of a dimension may include the validity of a corresponding dimension, a change in the dimension itself, or a change in the dimension value, such as appending, changing or deleting a value. Examples of detailed defined values of the field are shown in Table 1 below. Herein, the values shown in Table 1 define the changed made in the dimension.

TABLE 1

| | |
|---|---|
| 000 | Dimension invalid |
| 001 | Dimension value appended |
| 010 | Dimension value changed or deleted |
| 111 | Dimension valid |

As shown in Table 1, when the “dimension_update” field is ‘111’, the dimension of the RRT being received is defined to be valid. Herein, the validity of the dimension may include the dimension except deleting the dimension. In addition, for backward compatibility, it is preferable to define the value ‘111’ as ‘dimension valid’. The value ‘001’ indicates a simple appending of the dimension value. Herein, the appending of the dimension value refers to appending the value to the end of the original (or initial) dimension value. Therefore, a receiver will be used to the original (or initial) settings of the dimension in the value ‘001’.

The value ‘010’ indicates that the dimension value has been changed or deleted or the dimension itself has been changed. For example, a change in the dimension value refers to an adding of the dimension value, apart from the appending the dimension value to the end of the original dimension value. Unlike the value ‘111’ indicating that the dimension is valid and the value ‘000’ indicating that the dimension is invalid (or deleted), which will be described later on, the change in the dimension value refers to changing the original (or initial) settings of the dimension. Further, the change in the dimension value signifies a change in the dimension value that can change the original settings of the dimension with the exception of a simple appending of the value, which is represented as ‘001’. An example of the change in the dimension value may be to add a new dimension value to a plurality of original values. Finally, ‘000’ indicates that the dimension is invalid. Herein, ‘dimension invalid’ signifies that the dimension of the RRT being received is deleted.

Referring to Table 1, the “dimension_update” field is a 3-bit field, which may define a total of 8 states (or conditions). However, in this example, 4 states are defined in Table 1, and the remaining 4 states are reserved for future usage. Moreover, with the exception of ‘111’, which ensures backward compatibility, the other values may be defined arbitrarily. In other words, the values defined for updating the dimension in Table 1 are only examples given to simplify the description of the present invention.

Therefore, in case of the value ‘010’, instead of collectively defining a change in the dimension value as changing or deleting the dimension value, each value is defined separately. More specifically, ‘010’ indicates a adding of the dimension value, ‘100’ represents deleting the dimension value, and ‘101’ indicates that dimension itself is changed. Therefore, the definition of the change in the dimension value is only exemplary. Accordingly, the present invention should be understood based on the given information in Table 1.

As described above, FIG. 3 is another example for applying the changes in a dimension according to the present invention. Herein, the “dimension_update” field of FIG. 2 is described by 2 fields: a “dimension_valid” field and a “dimension_change” field. The “dimension_valid” field is a 1-bit field which determines the validity of the dimension of the RRT being received. The “dimension_change” field is a 2-bit field which defines the changed mode of the dimension. More specifically, when the RRT dimension is determined to be valid, the “dimension_change” field defines no change, a simple appending of a new dimension value to the end of the original dimension value, or a change or deletion of a dimension value.

The defined values of the “dimension_valid” field and the “dimension_change” field of FIG. 3 are respectively defined in detail in Table 2 and Table 3 below. In other words, Table 2 shows an example of the defined values of the “dimension_valid” field, and Table 3 shows an example of the defined values of the “dimension_change” field.

TABLE 2

| | |
|---|---|
| 0 | Dimension invalid |
| 1 | Dimension valid |

TABLE 3

| | |
|---|---|
| 00 | Dimension is not changed |
| 01 | Dimension is changed (simple appending only) |
| 10 | Dimension is changed (other than the simple appending) |
| 11 | Reserved |

As shown in Table 2, when the defined value of the “dimension_valid” field is ‘0’, the dimension is invalid. On the other hand, when the defined value is ‘1’, the dimension is defined to be valid. The definition of the validity of the dimension may be identical to that of Table 1.

As shown in Table 3, the values defined in the “dimension_change” field are basically assumed based upon the result of Table 2, which determines the dimension to be valid. More specifically, ‘11’ indicates that the dimension is valid but, since there is no change in the dimension, the original dimension remains unchanged. ‘01’ means that the dimension is valid. However, in this case, the current dimension is different from the previous dimension and, therefore, the dimension is changed. In other words, the dimension value is appended to the very end of the original (or initial) dimension value. Thus, the initial settings of the dimension remain unchanged.

‘10’ means that the dimension is valid. In this case, the current dimension is different from the previous dimension and, therefore, the dimension is changed. However, the simple appending of ‘01’ is excluded. Herein, the change in the dimension value signifies that a newly defined value is added or deleted to the original dimension values instead of the simple appending to the end of the original value. Finally, ‘00’ means that the dimension is reserved for future usage.

The dimension values of Table 3 are defined by using the 2-bit “dimension_change” field to correspond to the changes in the defined values of the dimension. However, the values defined in Table 2 and in Table 3 are only exemplary and should be understood in accordance with the technical spirit denoted within the description of the present invention. However, it is preferable to define the value ‘1’ of Table 2 as ‘dimension valid’ and the value ‘11’ of Table 3 as ‘Dimension is not changed’, so as to ensure backward compatibility.

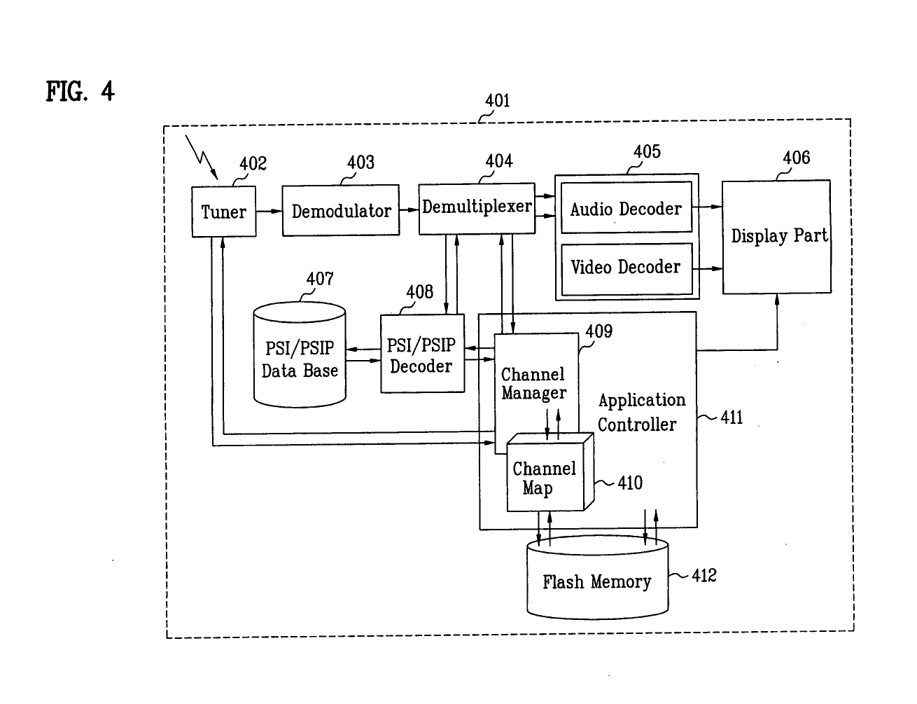

FIG. 4 illustrates an example of the structure of a digital television receiver for receiving and processing the rating region table (RRT) of a program and system information protocol (PSIP) according to the present invention. Referring to FIG. 4, a structure of the digital television receiver will now be described in detail.

The digital television receiver 401 according to the present invention includes a tuner 402, a demodulator 403, a demultiplexer 404, an A/V decoder 405, a display part 406, a PSI/PSIP database 407, a PSI/PSIP decoder 408, a channel manager 409, a channel map 410, an application controller 411, and a flash memory 412.

The tuner 402 may receive a digital television signal including a program and system information/program and system information protocol (PSI/PSIP) table. Herein, the received PSIP table includes a rating region table (RRT). And, the operations of the tuner 402 may be controlled by the channel manager 409. The tuner 402 can record the result of the received digital television signal in the channel manager 409. The demodulator 403 demodulates the tuned signal received from the tuner 402 to a vestigal side band/enhanced vestigal side band (VSB/EVSB) signal.

The demultiplexer 404 receives the demodulated signal from the demodulator 403 and demultiplexes the signal to audio data, video data, and PSI/PSIP table data. The demultiplexing of the audio data and video data may be controlled by the channel manager 409. On the other hand, the demultiplexing of the PSI/PSIP table data may be controlled by the PSI/PSIP decoder 408. More specifically, the demultiplexed audio data and video data are transmitted to the A/V decoder 405. The demultiplexed PSI/PSIP tables are transmitted to the PSI/PSIP decoder 408. Thereafter, the A/V decoder 405 receives the data from the demultiplexer 404 and decodes the received data.

The PSI/PSIP decoder 408 parses a PSI/PSIP table section and reads all remaining actual section data parts which the demultiplexer 404 did not filter, thereby recording the data in the PSI/PSIP database 407. The channel manager 409 refers to the channel map 410 and requests the reception of a channel related information table. Then, the channel manager 409 receives the results.

At this point, the PSI/PSIP decoder 408 controls the demultiplexing of the channel related information table and transmits an A/V PID list to the channel manager 409. The channel manager 409 uses the A/V PID received from the PSI/PSIP decoder 408 to directly control the demultiplexer 404, thereby controlling the A/V decoder 405. Furthermore, the application controller 411 controls a graphical user interface (GUI) which displays the condition (or state) of the digital television receiver system on an on-screen display (OSD).

More specifically, according to the present invention, the demultiplexer 404 uses the PID, table ID (table_id), version number (version_number), section number (section_number), and table ID extension (table_id_extension), so as to check a header part of the PSIP table being transmitted from a transmitting end (e.g., a broadcast station). At this point, the demultiplexer 404 filters a desired table. For example, the demultiplexer 304 filters a RRT.

The PSI/PSIP decoder 408 determines the changed state of the dimension in the filtered RRT and parses the RRT section so as to check (or verify) whether the RRT has been updated. Herein, the changed mode includes the validity and change in the dimension or the value of dimension of the RRT that is received and filtered.

Thereafter, the contents of the parsed RRT section are compared with those of a RRT pre-stored in the flash memory 412. In parsing and comparing the contents of the RRT, the values defined in the “dimension_update” field of the RRT syntax of FIG. 2 and the “dimension_valid” field and “dimension_change” field of the RRT syntax of FIG. 3 are parsed. Then, the contents of Table 1 to Table 3 are analyzed based upon the parsed values. Accordingly, the validity and update of the dimension or value of the dimension is determined, and the determined result is stored and updated (or upgraded) in the PSI/PSIP database 407.

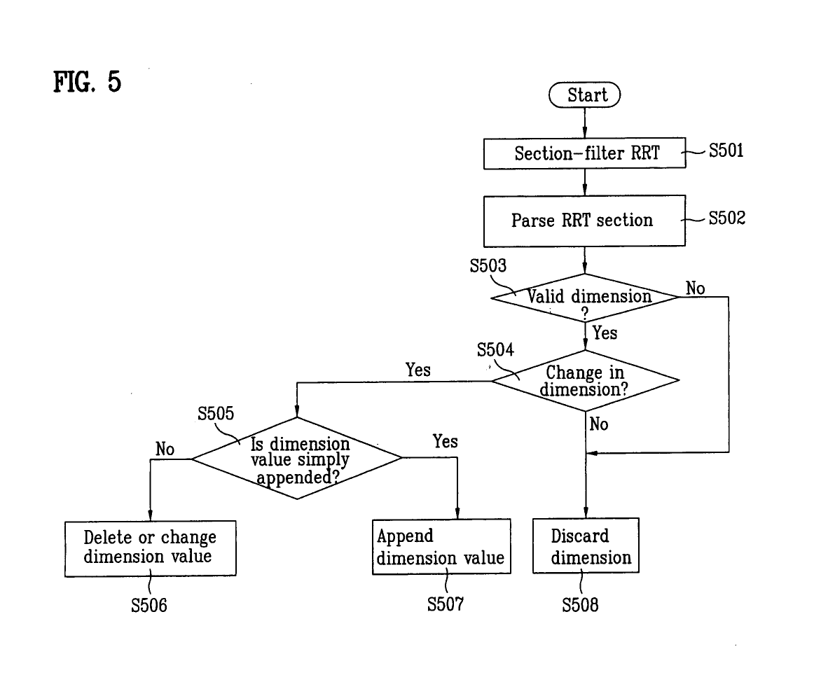

In the method for processing a digital television signal by using the above-described digital television receiver according to the present invention, FIG. 5 illustrates a flow chart showing the process steps of a method for receiving and processing the rating region table (RRT) of a program and system information protocol (PSIP) according to the present invention. The method will now be described in detail with reference to FIG. 5.

The power of a digital television receiver is turned on. Thereafter, a packet identifier (PID) is set to receive the rating region table (RRT) carrying rating information for multiple geographical regions from a master guide table (MGT). Then, by using the packet identifier (PID) for RRT of the parsed master guide table (MGT), section-filtering the RRT among the digital television signals being received (S501).

Subsequently, the section-filtered and received RRT section is parsed (S502). According to the present invention, the RRT section may either include the “dimension_update” field shown in FIG. 2 or include the “dimension_valid” field and “dimension_change” field shown in FIG. 3. In other words, in Step 502 the values defined in the “dimension_update” field of FIG. 2 or the values defined in the “dimension_valid” field and “dimension_change” field of FIG. 3 are parsed. hereafter, based upon the parsed result, the receiver determines whether the dimension of the parsed RRT is valid or invalid (S503). In Step 503, in determining whether the dimension of the parsed RRT is valid or invalid, either the value of the “dimension_update” field of FIG. 2 or the values of the “dimension_valid” field and “dimension_change” field of FIG. 3. may be used.

When using the field defined in FIG. 2, the receiver compares the “dimension_update” field value with Table 1, so as to determine the validity of the dimension. Referring to Table 1, if the value of the parsed “dimension_update” field is one of ‘111’, ‘001’, and ‘010’, the dimension value is determined to be valid. Conversely, if the value of the parsed “dimension_update” field is ‘000’, the dimension value is determined to be invalid. Once the dimension is determined to be invalid, the receiver deletes (or discards) the corresponding dimensions. Alternatively, when using the field defined in FIG. 3, the receiver compares the “dimension_valid” field value with Table 2, so as to determine the validity. Referring to Table 2, if the value of the parsed “dimension_valid” field is ‘0’, the dimension value of the RRT being received is determined to be invalid. Conversely, if the value is ‘1’, the dimension value of the RRT being received is determined to be invalid.

Based upon the determined result, if the dimension of the received RRT is determined to be valid, then a change of the dimension value of the received RRT is determined (S504). Herein, in case of FIG. 2, the change mode of the parsed dimension is determined by using the parsed dimension with the parsed “dimension_update” field. On the other hand, in case of FIG. 3, the mode of the dimension is determined by using the parsed dimension with the parsed “dimension_change” field. More specifically, the value of the parsed “dimension_update” field of FIG. 2 is compared with the values defined in Table 1. Herein, if the parsed “dimension_update” field value is ‘111’, the dimension value of the received RRT is valid. However, this may also indicate that no change is made in the dimension. Therefore, the parsed dimension is discarded (S508).

Subsequently, a simply append of the dimension value of the received RRT is determined (S504). Herein, in case of FIG. 2, if the value is ‘001’, the dimension value of the received RRT is valid, and the dimension is changed by simply appending the dimension value to the initial (or original) value (S507). Furthermore, if the value is ‘010’, the dimension value of the received RRT is valid, and the dimension value is either changed or deleted (S506).

Finally, in case of FIG. 3, the value of the parsed “dimension_change” field is compared with the values defined in Table 3. If the parsed “dimension_change” field value is ‘00’, it is determined that no change is made in the dimension. Therefore, it is discarded the parsed dimension (S508). If the value is ‘01’, the dimension of the received RRT is changed, however, the dimension is changed by simply appending a new value to the end of an initially defined dimension value (S507). If the value is ‘10’, the dimension of the received RRT is changed. In this case, the change indicates that the initial dimension value cannot be maintained (or preserved). In other words, the initially defined dimension value is deleted or changed, or a new dimension value is added (or inserted) between the initially defined values (S506). Accordingly, based upon the determined result, if the dimension value is changed, then the dimension value is updated.

As described above, in the digital television signal, the method of receiving the digital television signal, and the digital television receiver according to the present invention a dimension of the rating region table (RRT) can not only be appended and but also be deleted or changed. Accordingly, the present invention can provide convenient rating settings, so as to allow the user to easily recognize any change in a rating region table (RRT), such as deleting or changing the dimension.

Although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A digital television signal for use in a digital television receiver for receiving program and system information protocol (PSIP) data from a broadcast transmitter, the digital television signal comprising a rating region table carrying rating information for multiple geographical regions, wherein the rating region table comprises:
a first multiple string structure containing a first multiple string structure which represents a name of a dimension;
rating value information defining one or more rating values associated with the dimension; and
a first data field including information specifying a change mode of the rating value information which indicates whether and how the rating value information is changed.

2. The digital television signal of claim 1, wherein the change mode of the rating value information is any one of a first mode in which a new rating value is appended, and a second mode in which a rating value is changed or deleted.

3. The digital television signal of claim 1, wherein the change mode of the rating value information is any one of a first mode in which a new rating value is appended, a second mode in which a rating value is changed or deleted, a third mode indicating that the dimension is invalid, and a fourth mode indicating that the dimension is valid.

4. The digital television signal of claim 1, wherein the change mode of the rating value information is any one of a first mode in which there is no change in the rating value information, a second mode in which a new rating value is appended, and a third mode in which a rating value is changed or deleted.

5. The digital television signal of claim 1, wherein the change mode of the rating value information is any one of a first mode in which there is no change in the rating value information, and a second mode in which there is a change in the rating value information.

6. The digital television signal of claim 1, wherein the rating region table further comprises a second data field including information identifying the dimension as one of a valid dimension and an invalid dimension.

7. The digital television signal of claim 1, wherein the rating value information includes a second data field specifying a total number of the rating values being defined by the rating value information.

8. The digital television signal of claim 1, wherein the rating value information includes a second data structure containing a second multiple string structure which represents an abbreviated name for a particular rating value.

9. The digital television signal of claim 7, wherein the rating value information further includes a third data structure containing a third multiple string structure which represents a full name for the particular rating value.

10. A method of processing a digital television signal in a digital television receiver, the method comprising:
receiving a digital television signal including a rating region table carrying rating information for multiple geographical regions;
parsing the rating region table, the parsed rating region table comprising rating value information defining one or more rating values associated with a dimension and a first data field including information specifying a change mode of the rating value information; and
controlling storage of the rating value information based upon the change mode of the rating value information.

11. The method of claim 9, wherein the change mode of the rating value information is any one of a first mode in which a new rating value is appended, and a second mode in which a rating value is changed or deleted.

12. The method of claim 9, wherein the change mode of the rating value information is any one of a first mode in which a new rating value is appended, a second mode in which a rating value is changed or deleted, a third mode indicating that the dimension is invalid, and a fourth mode indicating that the dimension is valid.

13. The method of claim 9, wherein the change mode of the rating value information is any one of a first mode in which there is no change in the rating value information, a second mode in which a new rating value is appended, and a third mode in which a rating value is changed or deleted.

14. The method of claim 9, wherein the change mode of the rating value information is any one of a first mode in which there is no change in the rating value information, and a second mode in which there is a change in the rating value information.

15. The method of claim 9, wherein the rating region table further comprises a second data field including information identifying the dimension as one of a valid dimension and an invalid dimension.

16. The method of claim 9, wherein the rating value information includes a second data field specifying a total number of the rating values being defined by the rating value information.

17. The method of claim 9, wherein the rating value information includes a second data structure containing a second multiple string structure which represents an abbreviated name for a particular rating value.

18. The method of claim 16, wherein the rating value information further includes a third data structure containing a third multiple string structure which represents a full name for the particular rating value.

19. A digital television receiver, comprising:
a tuner arranged to receive a digital television signal;
a demodulator arranged to demodulate the digital television signal;
a demultiplexer arranged to demultiplex a rating region table from the demodulated digital television signal;
a decoder arranged to parse the rating region table, the parsed rating region table comprising rating value information defining one or more rating values associated with a dimension and a first data field including information which specifies a change mode of the rating value information; and
a controller arranged to control storage of the rating value information based upon the change mode of the rating value information.

20. The digital television receiver of claim 18, wherein the change mode of the rating value information is any one of a first mode in which a new rating value is appended, and a second mode in which a rating value is changed or deleted.

21. The digital television receiver of claim 18, wherein the change mode of the rating value information is any one of a first mode in which a new rating value is appended, a second mode in which a rating value is changed or deleted, a third mode indicating that the dimension is invalid, and a fourth mode indicating that the dimension is valid.

22. The digital television receiver of claim 18, wherein the change mode of the rating value information is any one of a first mode in which there is no change in the rating value information, a second mode in which a new rating value is appended, and a third mode in which a rating value is changed or deleted.

23. The digital television receiver of claim 18, wherein the change mode of the rating value information is any one of a first mode in which there is no change in the rating value information, and a second mode in which there is a change in the rating value information.

24. The digital television receiver of claim 18, wherein the rating region table further comprises a second data field including information identifying the dimension as one of a valid dimension and an invalid dimension.

25. The digital television receiver of claim 18, wherein the rating value information includes a second data field specifying a total number of the rating values being defined by the rating value information.

26. The digital television receiver of claim 18, wherein the rating value information includes a second data structure containing a second multiple string structure which represents an abbreviated name for a particular rating value.

27. The digital television receiver of claim 25, wherein the rating value information further includes a third data structure containing a third multiple string structure which represents a full name for the particular rating value.
